(19) United States
(12) Patent Application Publication
(10) Pub. No.: US 2025/0093190 A1
(43) Pub. Date: Mar. 20, 2025

(54) CAPACITIVE SENSOR ASSEMBLY FOR A BULK MATERIAL DOSING DEVICE

(71) Applicant: Harro Hoefliger Verpackungsmaschinen GmbH, Allmersbach im Tal (DE)

(72) Inventor: Katharina Bohn, Allmersbach im Tal (DE)

(21) Appl. No.: 18/883,828

(22) Filed: Sep. 12, 2024

(30) Foreign Application Priority Data
Sep. 15, 2023 (EP) 23197629.1

(51) Int. Cl. G01F 11/00; G01F 11/24

(52) U.S. Cl. CPC G01F 11/006; G01F 11/003; G01F 11/24

(57) ABSTRACT

A capacitive sensor assembly is for a bulk material dosing device for determining the mass of dosing quantities produced via the bulk material dosing device. The sensor assembly has at least one sensor unit which includes a first electrode, a second electrode, and an insert positioned between the two electrodes. A measurement channel extending in a vertical direction is formed in the insert. A tensioning device acting on the relevant electrode is arranged in a horizontal direction on a side, facing away from the insert, of at least one electrode. At least the two electrodes and the interposed insert can, in the loosened state of the tensioning device, be displaced in the horizontal direction. A plurality of sensor units are arranged in a row extending in the horizontal direction, wherein in each case one tensioning device is arranged between the sensor units.

### CROSS-REFERENCE TO RELATED APPLICATIONS

This application claims priority of European patent application no. 23197629.1, filed Sep. 15, 2023, the entire content of which is incorporated herein by reference.

### TECHNICAL FIELD

The disclosure relates to a capacitive sensor assembly for a bulk material dosing device for determining the mass of dosing quantities produced via the bulk material dosing device.

### BACKGROUND

For example in the pharmaceuticals sector, but also in the field of food supplements or the like, bulk material in the form of powder, pellets, or micro-tablets are processed which have to be supplied for the intended dosage form in precisely measured sub-quantities or dosing quantities. Target containers, for example in the form of blister packs, two-piece capsules, or the like are filled with such measured dosing quantities of such a bulk material such that the user has at their disposal and can take corresponding individual doses.

Such bulk material is transferred on so-called drum dosing units, pipettes, or the like in individually measured dosing quantities which are then filled into target containers which are assigned in each case. A drum dosing unit used here by way of example includes a dosing drum which is provided at its circumference with at least one and generally with a plurality of dosing openings, wherein the dosing openings are delimited on the inside via a filter element and a reduced pressure can be applied to them through the filter element. Powder is sucked into the dosing openings by the action of the reduced pressure, wherein dosing quantities of the powder are formed, the volume of which corresponds to the volume of the respective dosing opening. The dosing quantities formed in such a way are then ejected from the dosing openings via elevated pressure and transferred to the target container.

It becomes clear from the above explanations that the dosing via a bulk material dosing unit which forms the basis of this application is volumetric dosing. However, as a rule the aim is to achieve dosing in which the measured dosing quantity has a specific mass within an allowable tolerance margin. It is thus important for the volumetric dosing that there is a relationship between the measured volume and the mass actually obtained here which is as repeatable as possible.

So-called advanced mass verification (AMV) systems are increasingly to check the dosing accuracy which is actually obtained, wherein a capacitive measuring device is used. The latter includes two electrodes which are arranged on either side of a measuring section and between which a capacitive field is formed. The dosing quantity blown out from the dosing opening falls through the capacitive measuring section and thus generates, by virtue of its dielectric properties, a change in field and consequently a capacitive measuring signal. When correctly calibrated, this measuring signal provides information about the mass of the dosing quantity and allows random or even 100% monitoring of the dosing process.

In order to form the measuring section, inserts made from plastic are used in which a through measurement channel is formed. Such inserts enable, inter alia, an optimal, repeatable, and largely parallel placement of the two electrodes relative to each other and also relative to the actual measuring section.

A difficulty that occurs in practice consists in pressing the electrodes as flat as possible against the outside of the insert. A further difficulty is constituted by the side-by-side positioning of a plurality of inserts arranged in a row. These inserts must have a certain spacing from one another and be oriented exactly relative to the individual fall paths of a plurality of dosing quantities which have been ejected simultaneously from a row of dosing openings. In order to achieve this, in the case of the sensors of the prior art, the electrodes are fixed via adjusting pieces. The width of the adjusting pieces is made the correct size by inserting films. This process is very complex and in addition pretensioning of the electrodes is not possible.

### SUMMARY

It is an object of the disclosure to provide a capacitive sensor assembly which can be adjusted easily and precisely.

This object is, for example, achieved by a capacitive sensor assembly for a bulk material dosing device for determining the mass of dosing quantities produced via the bulk material dosing device. The capacitive sensor assembly includes: a sensor unit including a first electrode, a second electrode, and an insert positioned between the first electrode and the second electrode, wherein a measurement channel extending in a vertical direction is formed in the insert; a tensioning device configured to act on a relevant one of the first electrode and the second electrode being arranged in a horizontal direction on a side, facing away from the insert, of at least one of the first electrode and the second electrode; at least the first electrode, the second electrode and the insert being configured, in a loosened state of the tensioning device, to be displaceable in the horizontal direction; wherein the sensor assembly includes a plurality of the sensor units and a plurality of the tensioning devices; and, wherein the plurality of the sensor units are arranged in a row extending in the horizontal direction, wherein one of the plurality of tensioning devices is arranged between each of the plurality of sensor units.

According to the disclosure, a capacitive sensor assembly is provided with at least one sensor unit, wherein the sensor unit has a first electrode, a second electrode, and an insert positioned between the two electrodes, wherein a measurement channel extending in a vertical direction is formed in the insert, wherein a tensioning device acting on the relevant electrode in a horizontal direction is arranged on a side, facing away from the insert, of at least one electrode, and wherein at least the two electrodes and the interposed insert can, in the loosened state of the tensioning device, be displaced in the horizontal direction.

The ability of the electrodes and the insert to be displaced allows exact positioning at the desired location. Two functions are performed at once by tightening the tensioning device. Firstly, the two electrodes and the interposed insert are pressed together to form a package, wherein the electrodes cling to the outside of the insert, positioned accurately and with pretension. Secondly, such a pressed-together unit consisting of the electrodes and inserts is reliably fixed in its selected position. The assembly time and effort are minimized. Exchanging the unit in the event of damage or a change of format is possible with minimal effort.

In a simple basic embodiment of the disclosure, it can be sufficient to arrange just a single tensioning piece on the side of just one electrode, while a fixed stop is, for example, positioned on the opposite side. In an expedient development, in each case one tensioning device acting on the relevant electrode in the horizontal direction is arranged on the respective side, facing away from the insert, of the two electrodes. By reciprocally tightening the two tensioning devices, not only can clamping of the electrodes to the insert be obtained but also lateral positional adjustment of the tensioned structural unit can be carried out sensitively and exactly.

According to the disclosure, a plurality of sensor units are arranged in a row extending in the horizontal direction, wherein in each case one tensioning device is arranged between the sensor units. Expediently, a plurality of and in particular all the tensioning devices can be displaced here in the horizontal direction in the loosened state. By sequentially tightening all the tensioning devices, all the initially still displaceable parts can be positioned accurately in the horizontal direction and then be fixed in the position they have assumed. The mutual spacings can be set by compensating even rough tolerances. At the same time, the electrodes are pressed, positioned accurately, against the outside of the insert such that they are oriented exactly with respect to the measurement channel or to the measuring section in order to obtain the desired measuring accuracy. Overall, a high degree of positional accuracy and hence a high quality in terms of the measuring accuracy is obtained with a short assembly time. In addition, a modular system is created which can be adapted simply in terms of the number of channels or measuring sections and also in terms of the formats which are employed.

Different structural approaches can be considered for the specific form of the tensioning device. In an expedient embodiment, the tensioning device includes a first tensioning element, a second tensioning element, and a tensioning screw tensioning the two tensioning elements against each other, wherein, at least at one of the two tensioning elements and in particular at both tensioning elements, a sliding slope in contact with in each case the other tensioning element is formed. The two tensioning elements are advantageously formed here as sliding parts with in each case a sliding slope. The construction has a simple and cost-effective structure. It reliably maintains the set position and the tensioning force applied. In addition, high tensioning distances can be implemented such that positional adaptations of the unit consisting of the electrodes and insert can be implemented over a large available travel.

### BRIEF DESCRIPTION OF DRAWINGS

The invention will now be described with reference to the drawings wherein:

FIG. 1 shows a schematic illustration in cross section of a bulk material dosing device, as exemplified by a drum dosing unit with a product store, with a dosing drum and with a capacitive sensor assembly for determining the mass of the individual dosing quantities;

FIG. 2 shows a schematic exploded illustration of parts of a tensioning device of the capacitive sensor assembly as part of the measuring device according to FIG. 1 with two tensioning elements, with a tensioning screw, and with a nut;

FIG. 3 shows a schematic illustration in longitudinal section of the measuring device according to FIGS. 1 and 2 in the untensioned state; and,

FIG. 4 shows the assembly according to FIG. 3 in the tensioned state, adjusted ready for operation.

### DETAILED DESCRIPTION

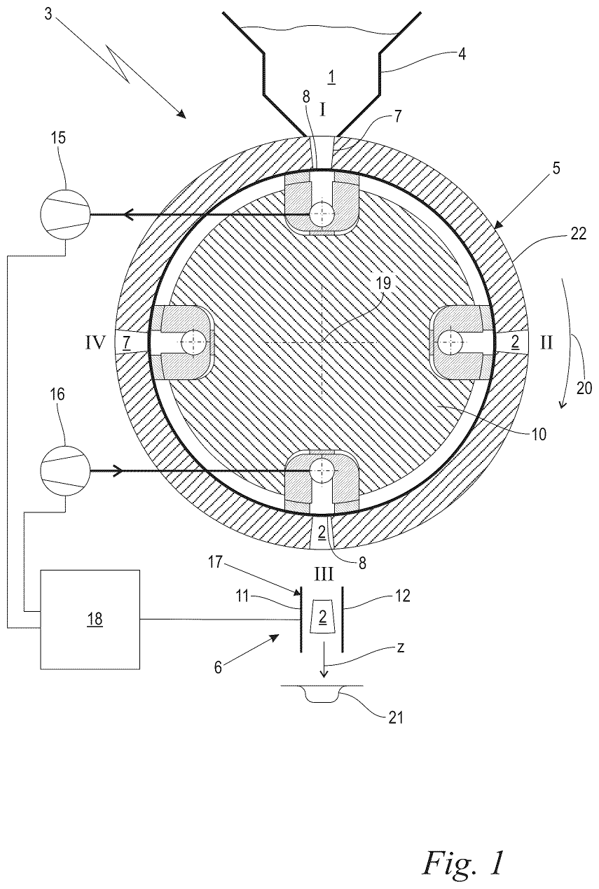

FIG. 1 shows a schematic illustration in cross section of a bulk material dosing device, as exemplified by a drum dosing unit 3 in the case of the production of individual dosing quantities 2 of a bulk material and for transferring such individual dosing quantities 2 into a target container 21. A slide dosing unit, a pipette, or any other suitable form of bulk material dosing device can also be provided instead of the drum dosing unit 3. The bulk material to be dosed is here a powder product 1 namely a pharmaceutical powder. It can, however, also be a food supplement or the like. Pellets, micro-tablets, or other bulk material can also be considered instead of a powder product 1. The target container 21 is here a schematically indicated blister pack which, after filling, is sealed with a covering foil. Two-piece capsules or other containers can also be considered as target containers 21, however.

The drum dosing unit 3 includes a product store 4, a dosing drum 5, and a capacitive measuring device 6. The capacitive measuring device 6 is also referred to as an advanced mass verification system or AMV system. The powder product 1 is held in the funnel-shaped product store 4 in order to be measured out. Subquantities of the powder product 1 are removed from the product store 4 via the dosing drum 5 and volumetrically exactly defined dosing quantities 2 are formed therefrom. A subsequent determination of the mass of individual, in particular all the dosing quantities 2, is effected via the capacitive measuring device 6.

The dosing drum 5 extends along a longitudinal axis is formed essentially cylindrically with respect to this longitudinal axis. At the circumference, it has at least one dosing opening 7. In the preferred embodiment shown, the dosing drum 5 is provided with a plurality of dosing openings 7. Although it is not visible in the illustration in cross section shown here, in each case two or three, up to twelve, dosing openings 7 form a row of openings which runs axially parallel to the axis of rotation 19. Four such rows of openings are positioned in the circumferential direction about the axis of rotation 19 at the same angular distances, that is, at 90° to one another. In each case one dosing opening 7 of the rows of openings can be seen here, that is, a total of four dosing openings 7. Different numbers of dosing openings 7 or rows of openings can, however, also be expedient in the axial direction and/or circumferential direction.

The dosing openings 7 are delimited radially outwardly and radially inwardly by filter elements 8. The dosing openings 7 have a volume specified in a defined manner between an outer side 22 of the dosing drum 5 and the radially inner filter elements 8. The filter elements 8 are permeable to air but not permeable for the bulk material, in this case therefore for the powder product 1. A reduced pressure from a reduced-pressure source 15 or an elevated pressure from an elevated-pressure source 16 can be applied to the dosing openings 7 through the respective filter element 8 as required, controlled by a control unit 18.

The dosing drum 5 is mounted rotatably about an axis of rotation 19 in the direction of an arrow 20 and provided with an associated rotary drive (not illustrated here). During operation, the dosing drum is rotated in cycles, wherein the individual dosing openings 7 are brought in at least two cycles periodically into an upper filling position I in the direction of gravity and a lower ejection position Ill in the direction of gravity. Continuous rotation can also be expedient instead of cycled movement. In the embodiment shown, the individual dosing openings 7 pass through four different positions in four cycles periodically, beginning with the upper filling position I, followed by a first intermediate position II. This is followed by the lower ejection position III and a second intermediate position IV before the cycle begins again at the upper filling position I.

In the upper filling position I, the respective dosing opening 7 is filled with the powder product 1 by forming a dosing quantity 2 from the product store 4. To do this, a reduced pressure from the reduced-pressure source 15 is applied to the dosing openings 7. The reduced pressure sucks the powder product 1 from the product store 4 into the dosing opening 7. A dosing quantity 2 of the powder product 1 which completely fills the dosing opening 7 is consequently formed, the volume of which corresponds to the volume of the dosing opening 7. In the subsequent first intermediate position II, a fill level check can optionally be performed. In the lower ejection position III, an elevated pressure from the elevated-pressure source 16 is applied to the dosing openings 7, as a result of which the dosing quantities 2 are ejected from the dosing openings 7 and fed to the respective target container 21. The dosing openings 7 which are now empty are moved on to the second intermediate position IV and can there optionally be cleaned, for example, by blowing out.

Part of the capacitive measuring device 6, already mentioned above, for determining the mass of the individual dosing quantities 2 is a capacitive sensor assembly 17 which is also connected to the control unit 18 and has two electrodes 11, 12 spaced apart from each other. The measurement data of the capacitive sensor 17 are detected and evaluated in the control unit 18, which as a whole leads to the formation of the measuring device 6. The dosing quantities 2 ejected from the dosing opening 7 in the lower ejection position III fall in a vertical direction z, under gravity, through between the electrodes 11, 12 of the capacitive sensor assembly 17 and into the target container 21. The mass of the dosing quantity 2 passing through is determined from the change in field which takes place here in the capacitive sensor assembly 17 in accordance with an AMV system. Although it is not absolutely necessary that the mass of each individual ejected dosing quantity 2 is determined, it can be sufficient if individual mass determinations are repeated randomly only after a few dosing cycles. However, mass determination is preferably carried out for 100% of the measured dosing quantities 2.

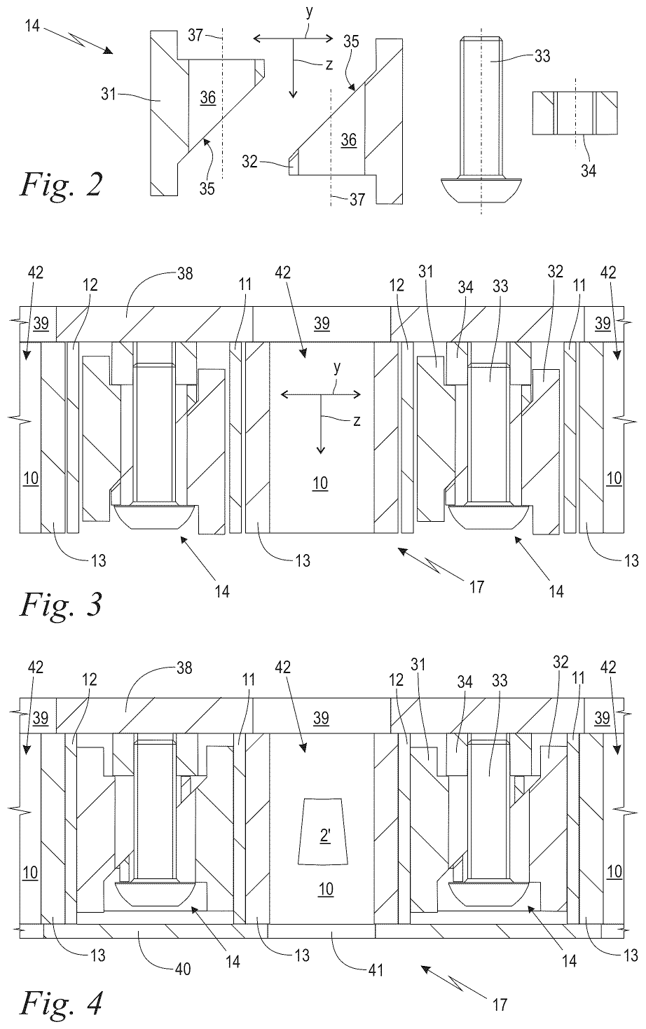

FIG. 2 shows a schematic exploded illustration of parts of a tensioning device 14 (FIGS. 3, 4) of the capacitive sensor assembly 17 as part of the measuring device 6 according to FIG. 1, with two tensioning elements 31, 32, with a tensioning screw 33, and with a nut 34. Instead of the nut 34, a threaded bore in a housing of the sensor assembly or a bore for receiving a self-cutting thread can also be expedient. All the parts are illustrated here in their installed positions relative to the vertical direction z (FIGS. 1, 3, 4). The tensioning screw 33 has an external thread and is oriented in the vertical direction z, wherein the nut 34 with its internal thread is also oriented so that it corresponds thereto.

The first tensioning element 31 is provided with a flat sliding slope 35 which is here at an angle of 45° to the vertical direction z. Different angles, in particular in a range from 30° to 60°, can, however, also be expedient. In the region of the sliding slope 35, the first tensioning element 31 is traversed by a slot 36, the slot axis 37 of which lies parallel to the vertical direction z and the widthwise cross-sectional axis of which runs parallel to a horizontal direction y.

The two tensioning elements 31, 32 are formed as identical parts with a sliding slope 35 in each case. In other words, the second tensioning element 32 is configured identically to the first tensioning element 31. The above statements regarding the first tensioning element 31 apply analogously to the physical features of the second tensioning element 32. It is, however, rotated by 180° about an axis running in the horizontal direction y such that the sliding slopes 35 of the two tensioning elements 31, 32 face each other in the assembled state.

FIG. 3 shows a schematic illustration in longitudinal section of the capacitive sensor assembly 17 according to FIGS. 1 and 2 in the untensioned state. The plane of section of the illustration according to FIG. 3 is spanned by the horizontal direction y running parallel to the axis of rotation 19 (FIG. 1) and the vertical direction z running in the direction of gravity.

According to the disclosure, the sensor assembly 17 has at least one and in this case a plurality of sensor units 42. An individual sensor unit 42 includes a first electrode 11, a second electrode 12, and an insert 13 positioned between the two electrodes 11, 12. In other words, the first electrode 11 is situated on one side of the respective insert 13 relative to the horizontal direction y and the second electrode 12 is situated on the opposite side. The pairs of first and second electrodes 11, 12 together form in each case a capacitor. These capacitors are connected to the control unit 18 (FIG. 1) to form the already mentioned capacitive measuring device 6. The inserts 13 are manufactured from plastic with suitable dielectric properties and lie within the field of the respective capacitor. A measurement channel 10 which runs in the vertical direction z and is continuous from top to bottom is formed in each case in each insert 13.

According to the disclosure, a tensioning device 14 acting on the relevant electrode 11, 12 in the horizontal direction y is arranged on a side, facing away from the insert 13, of at least one of the two electrodes 11, 12 of a sensor unit 42. In the embodiment according to FIG. 3, in each case one such tensioning device 14 is arranged on the respective side, facing away from the insert 13, of the two electrodes 11, 12 of each sensor unit 42. It can be seen in particular in FIG. 3 that a plurality of sensor units 42 are arranged in a row extending in the horizontal direction y, wherein in each case one tensioning device 14 is arranged between the sensor units 42. The interposed tensioning devices 14 accordingly act on both sides, namely on one side on one electrode 11 of a specific sensor unit 42 and on the other side also on the in each case other electrode 12 of the in each case adjacent sensor unit 42. The number of the inserts 13 with the respective measurement channel 10 formed therein corresponds to the number of dosing openings 7, described above in connection with FIG. 1, within a row of openings running parallel to the axis of rotation or parallel to the horizontal direction y. In the embodiment shown, there are thus two or three, up to twelve, inserts 13 with in each case one measurement channel 10 formed therein, wherein in each case one measurement channel 10 corresponds with in each case one dosing opening 7 of the relevant row of openings.

The tensioning devices 14 according to the disclosure in principle have a structure such that a tensioning procedure results in a widening of the respective tensioning device 14 in the horizontal direction y. In the structural implementation according to FIGS. 2, 3, for this purpose two tensioning elements 31, 32 bear against each other in pairs with their plane and flat sliding slopes 35, wherein their slots 36 at least partially overlap each other, and wherein the tensioning screw 33 traverses the slots 36 of the two tensioning elements 31, 32 and is screwed into the nut 34. Despite the tensioning screw 33 traversing them, the slots 36 allow a relative degree of displaceability of the two tensioning elements 31, 32 in the horizontal direction y.

According to FIG. 3, the tensioning devices 14 have not yet been tightened or tensioned. They are held in the vertical direction z between an upper base plate 38 and a lower counterplate 40 which has been illustrated only in FIG. 4 for better visibility. Both the base plate 38 and the counterplate 40 are provided with a row of openings 39, 41 which in terms of their number and mutual spacing correspond to the number and the spacing of the dosing openings 7 within a row of openings (FIG. 1). In the loosened state of the tensioning devices 14 according to FIG. 3, the electrodes 11, 12 and the insert 13 of all the sensor units 42 can be displaced in the horizontal direction y, which has been conveyed graphically by a horizontal mutual spacing of the parts. Also, all of the tensioning devices 14 can be displaced in the horizontal direction y in the loosened state shown. A fixed stop (not illustrated) against which the in each case outermost tensioning device 14 can be supported is situated in each case at the two lateral ends of the row of sensor units 42. It can, however, also be expedient to replace one of the two stops or alternatively both stops by a tensioning device 14 which is fixed in the horizontal direction y, that is, cannot be displaced. In this case, all the remaining tensioning devices 14, that is, all the tensioning devices 14 other than one or two of them, would then be displaceable in the horizontal direction y.

The respective tensioning device 14 is tensioned by tightening the tensioning screws 33 which press the pairs of tensioning elements 31, 32 against each other in the vertical direction z. The sliding slopes thus cause the tensioning elements 31, 32 to move apart from each other in the horizontal direction y and as a whole to cause the tensioning device 14 to be widened laterally. This lateral widening causes the tensioning device 14 to be applied laterally against the adjoining electrodes 11, 12 and press the latter against the outside of the respective insert 13.

FIG. 4 shows the assembly according to FIG. 3 with tensioning devices 14 tensioned in this way. Tensioning the tensioning devices has multiple effects according to the disclosure. On the one hand, the electrodes 11, 12 are pressed flat against the outside of respective insert 13 in such a way that the electrodes 11, 12 are oriented so that they are positioned accurately with respect to the respective measurement channel 10 inside the insert 13. On the other hand, by the coordinated tensioning of the tensioning elements, lateral positioning of the individual sensor units 42 relative to one another and also relative to the openings 39, 41 or to the fall paths of the individual dosing quantities 2 can be performed. The spacing and position of the sensor units 42 can thus be adjusted accurately and fixed in such a way that an individual dosing quantity 2 according to FIG. 4 falls through the center of the measurement channel 10 and thus generates an exactly reproducible capacitive measuring signal via the accurately oriented electrodes 11, 12.

The whole capacitive sensor assembly 17 can be disassembled by loosening the tensioning screws 33. The inserts 13 or also whole sensor units 42 can be exchanged easily and combined in the same number or any other desired number in a modular fashion.

It is understood that the foregoing description is that of the preferred embodiments of the invention and that various changes and modifications may be made thereto without departing from the spirit and scope of the invention as defined in the appended claims.

1. A capacitive sensor assembly for a bulk material dosing device for determining the mass of dosing quantities produced via the bulk material dosing device, the capacitive sensor assembly comprising:
a sensor unit including a first electrode, a second electrode, and an insert positioned between said first electrode and said second electrode, wherein a measurement channel extending in a vertical direction is formed in said insert;
a tensioning device configured to act on a relevant one of said first electrode and said second electrode being arranged in a horizontal direction on a side, facing away from said insert, of at least one of said first electrode and said second electrode;
at least said first electrode, said second electrode and said insert being configured, in a loosened state of said tensioning device, to be displaceable in the horizontal direction;
wherein the sensor assembly includes a plurality of said sensor units and a plurality of said tensioning devices; and,
wherein said plurality of said sensor units are arranged in a row extending in the horizontal direction, wherein one of said plurality of tensioning devices is arranged between each of said plurality of sensor units.

2. The sensor assembly of claim 1, wherein each of said plurality of tensioning devices acting on a corresponding one of said first and second electrodes in the horizontal direction is arranged on a respective side, facing away from said insert, of said first electrode and said second electrode.

3. The sensor assembly of claim 1, wherein a multiplicity of said plurality of tensioning devices are displaceable in the horizontal direction in the loosened state.

4. The sensor assembly of claim 1, wherein all of said plurality of tensioning devices are displaceable in the horizontal direction in the loosened state.

5. The sensor assembly of claim 1, wherein said tensioning device includes a first tensioning element, a second tensioning element, and a tensioning screw tensioning said first tensioning element and said second tensioning element against each other, wherein, at least at one of said first tensioning element and said second tensioning element, a sliding slope is formed; and, said sliding slope is in contact with in each case an other one of said first tensioning element and said second tensioning element.

6. The sensor assembly of claim 5, wherein, at both said first tensioning element and said second tensioning element, said sliding slope in contact with in each case the other one of said first tensioning element and said second tensioning element is formed.

7. The sensor assembly of claim 5, wherein said first tensioning element and said second tensioning element are formed as sliding parts with in each case said sliding slope.
